(19) United States
(12) Patent Application Publication
(10) Pub. No.: US 2002/0025199 A1
(43) Pub. Date: Feb. 28, 2002

(54) Image forming apparatus, image forming method and developing apparatus

(76) Inventor: Masaru Hibino, Ibaraki (JP)

Correspondence Address: FITZPATRICK CELLA HARPER & SCINTO, 30 ROCKEFELLER PLAZA, NEW YORK, NY, 10112, US

(21) Appl. No.: 09/916,339

(22) Filed: Jul. 30, 2001

(30) Foreign Application Priority Data
Jul. 31, 2000 (JP) 231751/2000

(51) Int. Cl. G03G 15/09

(52) U.S. Cl. 399/267; 399/277

(57) ABSTRACT

An image forming apparatus has a non-magnetic rotatable cylinder having a diameter of 10 mm to 25 mm, a plurality of magnetic field generating means which is inside the non-magnetic cylinder and fixed, a developing container which houses a two component developer containing a magnetic carrier and a non-magnetic toner and has the non-magnetic cylinder rotatably mounted at an opening portion thereof, agitating conveyer means which is inside the developing container and agitates the two component developer and conveys it to the non-magnetic cylinder, and an image bearing member arranged in opposition to the non-magnetic cylinder at intervals. The image forming apparatus is an image forming apparatus which conveys the two component developer by the rotation of the non-magnetic cylinder, and an electrostatic latent image on the image bearing member is magnetic-brush-developed.

### BACKGROUND OF THE INVENTION

### Field of the Invention and Related Background Arts

The present invention relates to an image forming apparatus and method for forming an image by developing an electrostatic latent image formed on an image bearing member corresponding to an image to be recorded and recording it on a recording medium such as a plain paper. Furthermore, the present invention relates to a developing apparatus used for the image forming apparatus.

Heretofore, various types of electrophotographic developing apparatuses have been proposed and put into practical use. In general, they are classified into the developing apparatuses based on a one component developing system and the developing apparatuses based on a two component developing system. The one component system is of non-contact system in most cases, and as its representative example, there is one component jumping developing system which uses a magnetic toner.

This developing system can provide a high quality image with a simple constitution. However, a clear color image cannot be provided because the toner contains a magnetic material. Further, in the case of the one component developing system using a non-magnetic toner, although a color image can be provided, it is difficult to have the toner applied to a developing sleeve stably for a long period. Even when the non-magnetic toner is coated on the developing sleeve with an elastic blade, it is necessary to further improve its stability and durability.

On the other hand, in the two component developing method, development is carried out by conveying the toner to a developing area by a magnetic carrier, and usually a developing process is carried out by bringing a developer into contact with a photosensitive drum. The developing process will be described with reference to FIG. 2. In FIG. 2, reference numeral 30 denotes a developing sleeve, reference numeral 35 a magnetic roller fixedly disposed inside the developing sleeve, reference numerals 31 and 32 agitating screws, reference numeral 33 a control blade disposed for forming the developer in a thin layer on the developing sleeve surface and reference numeral 34 a developing container.

The developing process for visualizing the above described electrostatic latent image by a two component magnetic brush method by using the above described developing apparatus and a circulating system of the developer will be described below. Accompanied with a rotation of the developing sleeve 30, the developer drew up at an N3 pole is controlled by the control blade 33 in the process of being conveyed from an S2 pole to an N1 pole and formed in a thin layer on the developing sleeve 30. When the developer formed in a thin layer is conveyed to a developing main pole S1, an ear-up is formed by a magnetic force. By the developer formed in the ear shape, the above described electrostatic latent image is developed, and, after that, the developer on the developing sleeve 30 is returned to the inside of the developing container 34 by a repulsive magnetic field of the N2 pole and the N3 pole. While, in the two component development, as described above, it is generally constituted in such a manner that the magnetic poles with the same polarity are arranged side by side and the developer after the development is once stripped off the developing sleeve so that no image hysteresis remains.

The developing sleeve is applied with a direct current bias and an alternating current bias from a power supply source (not shown). Generally in the two component developing method, by applying the alternating current bias, a developing efficiency is increased and an image quality is enhanced.

As for latent image forming methods, there have been known such methods wherein an electrophotographic photosensitive member is scan-exposed by a laser beam, which is modulated in correspondence with the signal of an image to be recorded, and an electrostatic latent image is formed by distributing the latent image in a dot shape in correspondence with the image. Among those methods, however, the so-called pulse width modulation (PWM) method which modulates the width (that is, the duration) of a laser drive pulse current in correspondence with the shade of the image to be recorded can obtain a high recording density (that is, a high resolution) and also can obtain a high graduation.

In recent years, development has been made to attain miniaturization and longevity of the two component developing device. In order to achieve the miniaturization from a development process side, it is necessary to miniaturize the container, the developing sleeve and the agitating conveyance screw. Making the space of a developer-reservoiring portion smaller at a developer layer thickness control portion is also one of the effective methods. Execution of these steps of miniaturization and spacelessness will severely reflect upon component accuracy and various latitudes and hence an elaboration of various ideas is necessitated.

In order to attain the longevity, it is necessary to prevent deterioration of the toner and the carrier. For this purpose, there is required a constitution wherein the developer is not compressed. The location in which the developer is compressed is the developer layer thickness control portion and, in a usual constitution, the developer layer thickness control pole (the S2 pole in FIG. 2) is situated in the upper stream of the rotational direction of the developing sleeve than the control blade and the developer attracted to a developer layer thickness control pole in this area is compressed between the sleeve and the container. To weaken the compression of the developer, it is most effective to weaken a force (Fr: a magnetic attraction force which works in the vertical direction to the developing sleeve) by which the developer layer thickness control pole attracts the developer to the developing sleeve.

As a method for that purpose, there can be cited such as minimizing a magnetization of the magnetic carrier inside the developer and constructing a magnet pattern in which a magnetic line of force from the developer layer thickness control pole is difficult to go around adjacent magnetic poles, but goes out as vertically as possible from the developing sleeve. Minimizing the magnetization of the carrier can be said to be one of means for achieving a high quality from a point that a force rubbing the toner image, which has been developed on the photosensitive member, becomes weaker.

As one of the latter methods, there has been proposed a developing method, which uses one of the repulsive magnetic poles of the magnet roller as a developer layer thickness control pole. When a repulsive magnetic field is formed with magnetic poles of the same polarity being side by side, the magnetic line of force of each magnetic pole goes out almost vertically to the developing sleeve. In this case, a rate of change in a magnetic flux density in the vertical direction to the developing sleeve is small. As a result, the force, which attracts the developer to the developing sleeve, becomes smaller and a condensation of the developer is weakened. It has been considered that, by adopting the above described both of the methods, still longer longevity can be attained.

Regarding a constitution to form the repulsive magnetic field, if the developer layer thickness control pole which is one of the repulsive magnetic poles is rather arranged in the downstream of the gravitational direction to the stripping off pole which is another magnetic pole forming the repulsive magnetic field, it is much easier to draw up the developer to be coated on the developing sleeve and the constitution becomes simpler. As described above, such a constitution has a possibility to reduce the reservoiring amount of the developer in the developer layer thickness control portion and leads also to the development of the miniaturization of the developing container.

However, in the case where the constitution using one of the repulsive magnetic poles as the developer layer thickness control pole is adopted for the developing sleeve of a small size, a screw pitch-like density irregularity is easy to occur at the rear end of a solid black image. This phenomenon occurs due to the fact that a mixing ratio of the developer (having an image hysteresis) with the toner density reduced which moves to the developer layer thickness control pole after having been stripped off by the repulsive magnetic field and the developer which is agitated and conveyed by the screw in the vicinity of the developing sleeve and supplied to the developer layer thickness control pole changes by a rotational cycle of the screw at a longitudinal image area.

The phenomenon as described above is apt to occur when the developer surface (the topmost surface of the developer conveyed by the screw) is situated relatively downward in the gravitational direction inside the developing container and the agitating conveyer screw is installed in the vicinity of the developer layer thickness control pole. Further, the above described phenomenon is apt to occur when a size of magnetization of the magnetic carrier is small. This is because, in the case of the above described constitution, the developer after development is hard to be stripped off by a stripping pole and easy to move to the developer layer thickness control magnetic pole.

### SUMMARY OF THE INVENTION

It is an object of the present invention to provide an image forming apparatus, an image forming method and a developing apparatus, wherein miniaturization and longevity of two component developer can be attained and a screw pitch-like density irregularity can be controlled.

It is an object of the present invention to provide an image forming apparatus, comprising: a non-magnetic rotatable cylinder having a diameter of 10 mm to 25 mm; a plurality of magnetic field generating means which is inside the non-magnetic cylinder and fixed; a developing container which houses a two component developer containing a magnetic carrier and a non-magnetic toner and has the above described non-magnetic cylinder rotatably mounted at an opening portion thereof; agitating conveyer means which is inside the developing container and agitates the two component developer and conveys it to the above described non-magnetic cylinder; and an image bearing member arranged in opposition to the non-magnetic cylinder at intervals,

wherein said image forming apparatus is an image forming apparatus which conveys the above described two component developer by the rotation of the non-magnetic cylinder and an electrostatic latent image on the image bearing member is magnetic-brush-developed,

the above described magnetic field generating means comprises: a developer layer thickness control pole for controlling a developer layer thickness on the above described non-magnetic cylinder of the developer supplied by the agitating conveyer means; and a stripping off pole comprising the same magnetic pole as the developer layer thickness control pole and arranged adjacent to the control pole in the upper side of the gravitational direction of the control pole and forming the magnetic field for stripping off the two component developer supplied for development from the non-magnetic cylinder,

the peak value of the strength of the magnetic field of the above described developer layer thickness control pole in the vertical direction to an outer peripheral surface of the above described non-magnetic cylinder is 0 tesla to 0.02 tesla in the absolute value not less than the peak value of the strength of the magnetic field of the above described stripping off pole in the vertical direction to the outer peripheral surface, and

the above described agitating conveyer means is installed in such a manner that the topmost surface of the developer conveyed by the agitating conveyer means is situated between the peak position of the strength of the magnetic field of the above described developer layer thickness control pole in the vertical direction to the outer peripheral surface of the above described non-magnetic cylinder and the peak position of the strength of the magnetic field of the above described stripping off pole in the above described direction.

Further, it is an object of the present invention to provide an image forming method, comprising: a non-magnetic rotatable cylinder having a diameter of 10 mm to 25 mm; a plurality of magnetic field generating means which is inside the non-magnetic cylinder and fixed; a developing container which houses a two component developer containing a magnetic carrier and a non-magnetic toner and has the above described non-magnetic cylinder rotatably mounted at an opening portion thereof; agitating conveyer means which is inside the developing container and agitates the two component developer and conveys it to the above described non-magnetic cylinder; and an image bearing member arranged in opposition to the non-magnetic cylinder at intervals, conveys the above described two component developer being conveyed by the rotation of the non-magnetic cylinder and an electrostatic latent image on the image bearing member being magnetic-brush-developed,

wherein the above described magnetic field generating means comprises: the developer layer thickness control pole for controlling the developer layer thickness on the above described non-magnetic cylinder of the developer supplied by the agitating conveyer means; and a stripping off pole comprising the same magnetic pole as the developer layer thickness control pole and arranged adjacent to the control pole in the upper side of the gravitational direction of the control pole and forming the magnetic field for stripping off the two component developer supplied for development from the non-magnetic cylinder,

the peak value of the strength of the magnetic field of the above described developer layer thickness control pole in the vertical direction to an outer peripheral surface of the above described non-magnetic cylinder is 0 tesla to 0.02 tesla in the absolute value not less than the peak value of the strength of the magnetic field of the above described stripping off pole in the vertical direction to the outer peripheral surface, and

the above described agitating conveyer means is installed in such a manner that the topmost surface of the developer conveyed by the agitating conveyer means is situated between the peak position of the strength of the magnetic field of the above described developer layer thickness control pole in the vertical direction to the outer peripheral surface of the above described non-magnetic cylinder and the peak position of the strength of the magnetic field of the above described stripping off pole in the above described direction.

Further, it is an object of the present invention to provide a developing apparatus, comprising: a non-magnetic rotatable cylinder having a diameter of 10 mm to 25 mm; a plurality of magnetic field generating means which is inside the non-magnetic cylinder and fixed; a developing container which houses a two component developer containing a magnetic carrier and a non-magnetic toner and has the above described non-magnetic cylinder rotatably mounted at an opening portion thereof; and agitating conveyer means which is inside the developing container and agitates the two component developer and conveys it to the above described non-magnetic cylinder,

wherein the above described developing apparatus is an developing apparatus which conveys the above described two component developer by the rotation of the non-magnetic cylinder and an electrostatic latent image on the image bearing member of the image forming apparatus comprising the image bearing member arranged in opposition to the non-magnetic cylinder at intervals is magnetic-brush-developed,

the above described magnetic field generating means comprises: the developer layer thickness control pole for controlling the developer layer thickness on the above described non-magnetic cylinder of the developer supplied by the agitating conveyer means; and a stripping off pole comprising the same magnetic pole as the developer layer thickness control pole and arranged adjacent to the control pole in the upper side of the gravitational direction of the control pole and forming the magnetic field for stripping off the two component developer supplied for development from the non-magnetic cylinder,

the peak value of the strength of the magnetic field of the above described developer layer thickness control pole in the vertical direction to an outer peripheral surface of the above described non-magnetic cylinder is 0 tesla to 0.02 tesla in the absolute value not less than the peak value of the strength of the magnetic field of the above described stripping off pole in the vertical direction to the outer peripheral surface, and

the above described agitating conveyer means is installed in such a manner that the topmost surface of the developer conveyed by the agitating conveyer means is situated between the peak position of the strength of the magnetic field of the above described developer layer thickness control pole in the vertical direction to the outer peripheral surface of the above described non-magnetic cylinder and the peak position of the strength of the magnetic field of the above described stripping off pole in the above described direction.

### BRIEF DESCRIPTION OF THE DRAWINGS

FIG. 1 is a longitudinal sectional view showing one example of an image forming apparatus for forming a full color image according to the present invention;

FIG. 2 is a sectional view showing a known developing device which was used when describing the conventional example; and

FIG. 3 is a sectional view of the developing device showing one example of the present invention.

### DETAILED DESCRIPTION OF THE PREFERRED EMBODIMENTS

According to the present invention, by adopting the constitution as described above, it is possible to miniaturize the apparatus and increase the longevity two component developer and, at the same time, an uniform and stable image can be obtained at the whole surface for a long period of time.

Further, the present invention is, if development is performed in the case where the image bearing member and the non-magnetic cylinder mutually move in a reverse direction at the developing portion, preferable in terms of further improvement of an image quality in the image forming.

Further, the present invention is, if the magnetic carrier in the two component developer has a magnetization of 3.0×10⁴ A/m to 2.0×10⁵ A/m in 0.1 tesla of magnetic field, preferable in terms of further improvement of the image quality in the image formation and the longevity of the carrier particle, the non-magnetic cylinder and the like.

The above described non-magnetic cylinder is taken as having the diameter of 10 mm to 25 mm as an index for achieving the miniaturization of the developing apparatus and the image forming apparatus. When the diameter of the non-magnetic cylinder deviates from the above described range, there sometimes occur the problems in that the magnetic field by the magnetic field generating means is not effectively formed and the longevity of the developer cannot be attained or the miniaturization of the apparatus cannot be achieved.

The non-magnetic cylinder is preferably formed by a conductive material and, as such a material, there can be illustrated various types of materials conventionally known, for example, a metal such as stainless and aluminum, a resin invested with conductivity by dispersion of conductive particles. Further, the non-magnetic cylinder may be given a process such as the surface roughening of a surface by a blasting process in order to enhance a conveyance ability of the two component developer.

The above described magnetic field generating means has a plurality of them fixed inside the non-magnetic cylinder so that they become relatively immovable against the non-magnetic cylinder. The magnetic field generating means may be either means such as a magnet always generating the magnetic field or means such as an electro-magnet capable of randomly generating a certain magnetic field or the magnetic field of a different polarity.

The above described developer layer thickness control pole is one of the magnetic field generating means and constituted in such a manner as to bear the magnetic carrier contained in the two component developer on the non-magnetic cylinder surface in a predetermined layer thickness. Further, the above described stripping off pole is similarly one of the magnetic field generating means and constituted in such a manner as to form the magnetic field for stripping off from the non-magnetic cylinder the developer returned to the inside of the developing container by being borne and conveyed on the non-magnetic cylinder after having been supplied for development. The stripping off pole and the developer layer thickness control pole are of the same polarity and, further, the stripping off pole is arranged upward of the gravitational direction of the developer layer thickness control pole.

When constituted as above, because both of the poles form the repulsive magnetic field, the magnetic line of force between both of the poles tends to emanate in the vertical direction to the non-magnetic cylinder outer peripheral surface. As a result, a rate of change of the magnetic field (a density of the magnetic line of force) in the above described direction becomes smaller and a force attracting the two component developer to the non-magnetic cylinder becomes smaller. For this reason, the developer is easy to drop while it passes over the stripping off pole and a recovery of the developer can be realized by a simple constitution.

Further, when constituted as above, because the magnetic line of force of the developer layer thickness control pole tends to emanate in the vertical direction to the non-magnetic cylinder outer peripheral surface, a force to press the developer to the non-magnetic cylinder becomes smaller and a force to compress the developer in the vicinity of the developer layer thickness control pole becomes weaker, so that the longevity of the developer is attained with a simple constitution.

Further, the peak value of the strength of the magnetic field in the vertical direction to the non-magnetic cylinder outer peripheral surface of the developer layer thickness control pole is taken in the absolute value as not less than 0 tesla or not more than 0.02 tesla of the peak value of the strength of the magnetic field in the vertical direction to the above described outer peripheral surface of the stripping off pole. Preferably, the above described peak value of the developer layer thickness control pole is not less than 0.04 tesla and not more than 0.1 tesla, and the above described peak value of the stripping off pole is not less than 0.04 tesla and not more than 0.08 tesla. According to this constitution, the circulation of the developer becomes smoother around the non-magnetic cylinder.

To describe the range of the difference of the above described peaks, when the peak value is below 0 tesla (that is, the strength of the magnetic field of the developer layer thickness control pole is smaller than the strength of the magnetic field of the stripping off pole), the returned developer in the vicinity of the stripping off pole reservoirs too much, while the developer in the vicinity of the developer layer thickness control pole reservoirs too small. Thus, the irregularity of the developer on the non-magnetic cylinder is easy to occur and an image faulty sometimes is produced. Further, when the peak value is not less than 0.02 tesla, the developer stripped off from the non-magnetic cylinder is attracted to the developer layer thickness control pole without being influenced by the agitation by the agitating conveyer means to be described later and supplied to the next development with an image hysteresis remaining undeleted, so that an image faulty due to a decreasing an image density and a pitch irregularity of the agitating conveyer means are sometimes produced.

The peak value of the strength (Br) of the magnetic field of the above described both of the poles can be measured by the following method.

In the present invention, in order to calculate a magnetic flux density Br of a normal direction in the position on the developing sleeve (the non-magnetic cylinder) surface, a measurement was made by a gauss meter Model 640 manufactured by Bell Co. The developing sleeve was horizontally fixed and a magnet (magnetic field generating means) inside the developing sleeve is rotatably attached. The above described gauss meter has a measuring probe which keeps a very minute gap with the developing sleeve and is horizontally fixed in such a manner that the center of the developing sleeve and the center of this probe are almost on the same horizontal plane. This measuring probe is connected with the gauss meter and measures the magnetic flux density on the developing sleeve surface. The developing sleeve is almost coaxial with the magnet and the gap between the developing sleeve and the magnet may be considered to be equal at any place. Accordingly, by rotating the magnet, the magnetic flux density Br of the normal direction in the position on the developing sleeve can be measured for all of the peripheral directions. The peak value of the strength of the magnetic field can be calculated from this measuring result for both dimension and position.

If the constitution is only as described above, the stripped off developer drops and is influenced as it is by the developer layer thickness control pole. However, in the present invention, the agitating conveyer means is used, and this agitating conveyer means is installed in such a manner that the topmost surface of the developer conveyed by the agitating conveyer means is positioned between the position of the peak strength of the magnetic field of the developer layer thickness control pole and the position of the peak strength of the magnetic field of the stripping off pole.

According to this constitution, the returned developer which was stripped off from the non-magnetic cylinder at the stripping off pole, when dropped, reaches the agitating conveyer means before being influenced by the magnetic field of the developer layer thickness control pole and is agitated with another (for example, new) developer and hence the image hysteresis is deleted until it is conveyed again to the non-magnetic cylinder and a supply of the developer is continued without producing any image faulty.

As such agitating conveyer means, there can be cited various types of conventionally known means. For example, agitating conveyer apparatus in which a rotary arm is installed with an elastic resin plate or a conveyance screw in which a body of rotation is installed with a screw-shaped blade can be cited. In the present invention, it is preferable that a conveyance screw, which has a good agitating efficiency at the conveying time, be used. When the agitating conveyer means is constituted by utilizing a body of rotation having an axis of rotation extending in the same direction as the non-magnetic cylinder, it is preferable that its rotational direction be a counter direction to the rotational direction of the non-magnetic cylinder.

The above described developing container is good if it is a developing container adequately used for housing the two component developer and a variety of constitutions can be used, which have been conventionally known. The developing container forms more than two housing spaces with a partition wall installed in its inside, and one housing space can be taken as a space for supplying to the non-magnetic cylinder and the other housing space can be taken as a space for supplying a new developer to the above described space. It is preferable that the other housing space be installed with another agitating conveyer means for agitating the developer to be housed and conveying it to the adjacent space. Further, it is preferable that the above described another space be installed with replenishing means for replenishing a new non-magnetic toner as occasion demands.

In addition to the above described constitution, in the present invention, the above described another agitating conveyer means, replenishing means and another member such as a control blade for controlling the layer thickness of the developer on the non-magnetic cylinder can be further provided. Further, in the present invention, each apparatus and the like which constitute the image forming apparatus including the developing apparatus of the present invention can be made into a form of the process cartridge which is integrally and detachably or attachably constituted.

Further, in the present invention, though a process direction in development is not particularly limited, the development is preferably performed by moving the image bearing member and the non-magnetic cylinder in an opposite direction in order to prevent reservoiring of the developer in the developing portion from occurring and form the image of a higher quality. The developing portion means an opposing portion between the image bearing member and the non-magnetic cylinder, which is an area where the movement of the toner in the developer to the image bearing member is performed.

The two component developer used in the present invention contains a non-magnetic toner and a magnetic carrier.

The non-magnetic toner is not particularly limited, if it is the non-magnetic toner which has been known and used in the two component developer. The non-magnetic toner is constituted by using an adequate amount of a binder resin such as styrene system resin or polyester resin; coloring agent such as carbon black, dyes, pigment and the like; releasing agent such as wax; and charge controlling agent. Such a non-magnetic toner can be produced by a normal method such as a pulverizing method and a polymerizing method.

It is preferable that the non-magnetic toner has an amount of frictional electrification of −1×10⁻² to −4.5×10⁻² C/kg. If the amount of frictional electrification of the non-magnetic toner deviates from the above described range, a developing efficiency is easily reduced and the image faulty is sometimes produced. The amount of frictional electrification of the non-magnetic toner may be adjusted by the types of materials to be used and the like or may be adjusted by the external additive to be described later.

The amount of frictional electrification of the non-magnetic toner can be measured by the usual blow-off method by drawing up the toner from the developer with the toner amount taken as about 0.5 to 1.5 g by drawing up an air and by measuring a charged amount induced in a measuring container.

Further, it is preferable that the non-magnetic toner has a volume average particle size of 4 to 15 μm. Here, for the volume average particle size of the non-magnetic toner, for example, the numerical value measured by the following measurement method is adopted.

As for a measuring apparatus, a Coulter counter Model TA-II (manufactured by Coulter, Inc.) is used, and an interface (manufactured by NIKKAKI CO., LTD.) for outputting a number average distribution and a volume average distribution and a personal computer Model CX-i (manufactured by Canon Inc.) are connected, and an electrolytic solution uses a first grade sodium chloride to adjust 1% NaCl aqueous solution.

As for the measuring method, a surface active agent (preferably alkylbenzenesulfonic acid salt) of 0.1 to 5 ml as a dispersing agent is added to the above described electrolytic solution of 110 to 150 ml, and a measuring sample of 0.5 to 50 mg is further added.

The electrolytic solution which suspended the sample performs a dispersing process for about one to three minutes by an ultrasonic dispersing device and measures a particle size distribution of the particle of 2 to 40 μm and calculates a volume distribution by using a 100 μm aperture as an aperture by the above described Coulter counter Model TA-II. By these calculated volume distributions, the volume average particle size of the sample can be obtained.

As for a magnetization of the above described magnetic carrier, what is conventionally known can be used. For example, a resin carrier which is formed by dispersing magnetite as a magnetic material in the resin and making it conductive and dispersing carbon black for a resistance adjustment purpose, or the carrier subjected to a resistance adjustment by oxidizing or deoxidize-processing the surface of a magnetic carrier core particle such as a ferrite particle, or the carrier subjected to a resistance adjustment by coating the surface of a magnetic carrier core particle such as a ferrite with a resin can be used. The production method of these magnetic carriers is not particularly limited.

It is preferable that the above described magnetic carrier has a magnetization of 3.0×10⁴ A/m to 2.0×10⁵ A/m in the magnetic field of 0.1 tesla. When the magnetization of the magnetic carrier is smaller than the above described range, a stable adhesion of the above described magnetic generating means to the non-magnetic cylinder becomes difficult and an image faulty such as a decreasing of an image density and the like is sometimes produced. Further, when the magnetization of the magnetic carrier is larger than the above described range, a compression of the developer while being conveyed by the non-magnetic cylinder becomes stronger and the longevity of the developer is sometimes not attained.

The magnetization of the carrier was measured by using an oscillation magnetic field type magnetic property automatic recording apparatus BHV-30 made by Riken Denshi Co., Ltd. The magnetic property value of carrier powder is obtained by strength of the magnetization when an external magnetic field of 0.1 T is created. The carrier is in a packed state so as to be sufficiently tight in a plastic container of a cylindrical shape. In such a state, a magnetization moment is measured and an actual weight at the time the sample was put in is measured, and the strength of the magnetization is calculated (Am²/kg). Subsequently, a true specific gravity of the carrier particle is calculated by a dry type automatic density meter accupick 1330 (manufactured by Shimadzu Corp.) and, by multiplying the strength of the magnetization (Am²/kg) by the true specific gravity, the strength (A/m) of the magnetization per a unit volume used in the present invention is calculated.

Further, it is preferable that the above described magnetic carrier has a weight average size of 20 to 100 μm and still further 20 to 70 μm. When the weight average size of the magnetic carrier is smaller than the above described range, the conveyance ability of the non-magnetic toner sometimes becomes insufficient and, when it is larger than the above described range, it sometimes adversely affects a flowability, a chargeability and a conveyance ability of the two component developer.

The weight average size of the magnetic carrier may be measured similar to or corresponding to the measurement of the particle size of the above described non-magnetic toner or may be measured by a sifting method wherein sieves of different meshes are piled up on another in order of large mesh size and a sifting out is performed by putting a sample previously measured for the weight on a topmost and a residual amount on each mesh is measured and displayed by an integrating percentage with a total amount.

The above described two component developer may be a developer containing another material which is suitably used in addition to the above described non-magnetic toner and the magnetic carrier. As such another material, an external additive and the like for controlling a flowability and a chargeability of the developer can be cited.

The external additive has two effects hardware-wise for the non-magnetic toner and further by coating the surface of the non-magnetic toner. One of them is that the flowability is improved so that a replenished toner can be easily mixed and agitated with the two component developer inside the developing container and another is that the external additive intervenes on the toner particle surface so that a releasing ability to the photosensitive drum of the non-magnetic toner supplied onto the photosensitive drum by the developer is enhanced, thereby improving a transfer efficiency.

As for the external additive used in the present invention, in terms of the durability at the time when it was added to the non-magnetic toner, it is preferable that it has a numerical value of the number average particle size equal to or less than 1/10 of the numerical value of the weight average size of the non-magnetic toner particle. What is meant by the particle size and the number average particle size of the external additive is the average particle size calculated from the surface observation of the toner particle in an electron microscope.

As for the external additive, various types of inorganic and organic chemical compounds, which have been conventionally known as the external additives, can be used. For example, metallic oxide (such as aluminum oxide, titanic oxide, titanic acid strontium, cerium oxide, magnesium oxide, chromic oxide, tin oxide, zinc oxide and the like), nitride (silicon nitride), carbide (such as silicon carbide), metallic salt (such as calcium sulfate, barium sulfate, calcium carbonate and the like), fatty acid metallic salt (such as zinc stearate, calcium stearate and the like), carbon black, silica and the like can be cited.

The external additive is used in 0.01 to 10 parts by weight based on 100 parts by weight of the non-magnetic toner particle and preferably is used in 0.05 to 5 parts by weight. The external additive may be singly used or jointly used with a plurality of additives. Further, it is much preferable to use the additives, which are respectively subjected to a hydrophobic treatment.

The examples of the present invention will be described below with the accompanied drawings.

### EXAMPLE 1

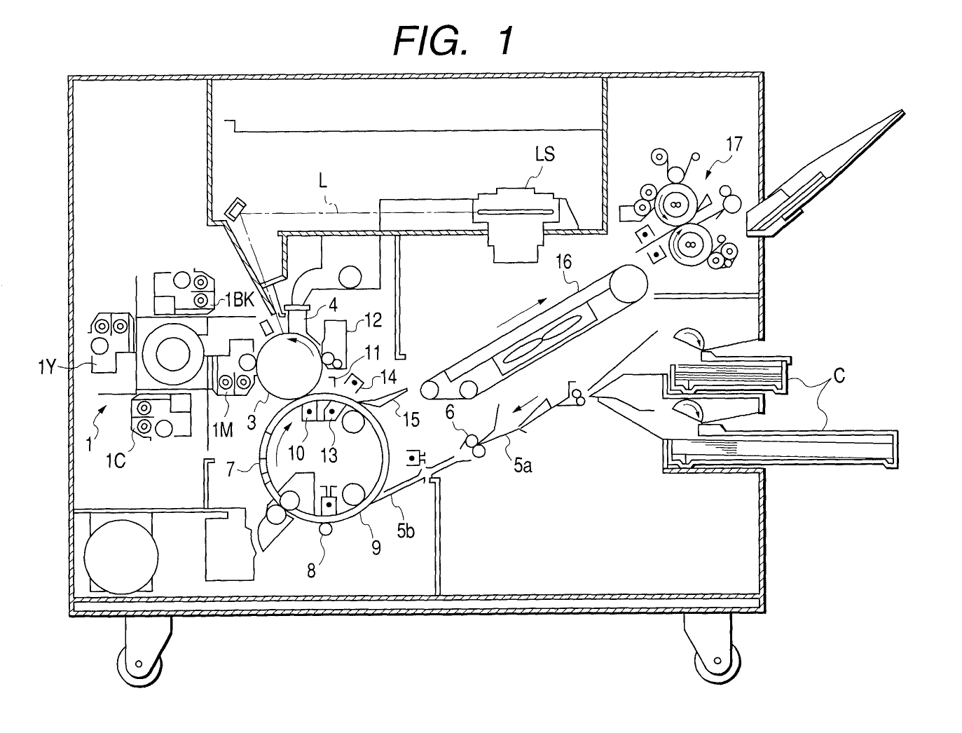

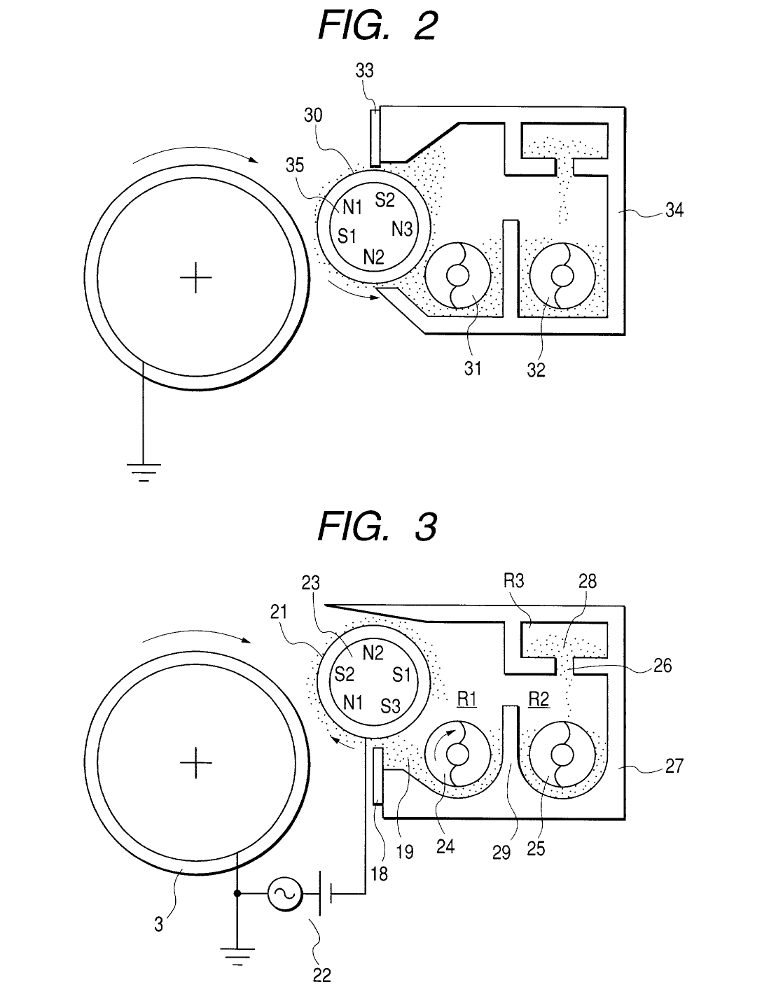

FIG. 1 shows a color printer of an electrophotographic system which the present invention can adopt. This printer comprises an electrophotographic photosensitive drum (an image bearing member) 3 which rotates in an arrow direction and, around the photosensitive drum 3, there are arranged a rotational developing apparatus 1 comprising a charging device 4 and developing devices (developing apparatuses) 1M, 1C, 1Y and 1Bk, a transfer charging device 10, cleaning means 12 and image forming means comprising LED exposure means and the like installed upward of the drawing of the photosensitive drum 3. In each developing device, two component developer containing a non-magnetic toner and a magnetic carrier particle is housed. The developer of the developing device 1M houses a non-magnetic magenta toner and the magnetic carrier, the developer of the developing device 1C a non-magnetic cyan toner and the magnetic carrier, the developer of the developing device 1Y a non-magnetic yellow toner and the magnetic carrier and the developer of the developing device 1Bk a non-magnetic black toner and the magnetic carrier.

An original to be copied is read by an original reading device not shown. This reading device comprises a photoelectric transfer element (for example, CCD), which converts an original image into electric signals and outputs image signals respectively corresponding to a magenta image information, a cyan image information, a yellow image information and a black and white image information of the original. LED exposure means is controlled for an on-off emission corresponding to these image signals and performs an exposure. It can also print out output signals from an electronic calculator. The whole sequence of the color printer will be briefly described with reference to the case of a full color mode.

The charging device 4 uniformly charges the photosensitive drum 3. Next, an exposure is performed by an LED array L controlled by the magenta image signal, and a dot distribution latent image is formed on the photosensitive drum 3. This latent image is reversely developed by the magenta developing device IM which is fixed in advance on the developing position.

The transfer material such as a paper which was taken out from a cassette C and advanced through a paper feed guide 5a, a paper feed roller 6 and a paper feed guide 5b is held by a gripper 7 of a transfer drum 9 and electrostatically wound around the transfer drum 9 by an abutting roller 8 and its opposing pole. The transfer drum 9 rotates in the illustrated arrow direction by synchronizing with the photosensitive drum 3, and a magenta manifested image developed by the magenta developing device IM is transferred on the transfer material by the transfer charging device 10 in the transfer portion. The transfer drum 9 continues its rotation as it is and prepares for the transfer of the next color (cyan in FIG. 1) image.

On the other hand, the photosensitive drum 3 is charge-neutralized by the charging device 11, cleaned by the cleaning means 12, charged again by the charging device 4 and subjected to the exposure as described above by the LED array L controlled by the next cyan image signal, thereby forming an electrostatic latent image. During this time, the developing apparatus 1 rotates and, with the cyan developing device IC stationed in a predetermined developing position, performs a reversal developing of the electrostatic latent image corresponding to cyan and forms a cyan manifested image.

Subsequently, the following steps are performed for the yellow image signal and the black image signal, respectively and, when the transfer of a four-color manifested image (a toner image) is completed, the transfer material is charge-neutralized by each charging device 13, 14 and releases the above described gripper 7 and, at the same time, is separated from the transfer drum 9 by a separating claw 15 and forwarded to a fixing device (a hot pressing roller fixing device) 17 by a conveyer belt 16. The fixing device 17 fixes the four color manifested images superposed on the transfer material. In this way, a series of the full color print sequence is completed and a desired full color print image is formed.

The present constitution is one example and there are various systems where, for example, the charging device 4 is not a corona charging device, but a charging roller and the exposure means is a semiconductor laser and the transfer charging device 10 is also a transfer roller. However, basically as described above, going through the steps of charging, exposing, developing, transferring and fixing forms the image.

Next, one of the developing devices, 1M in the image forming method of the present invention will be described with reference to the drawings.

FIG. 3 is a block diagram showing the developing device 1M used in the example of the present invention. The present developing device is, as shown in FIG. 3, provided with a developing container 27. The inside of the developing container 27 is zoned as a developing chamber (the first chamber) R1 and an agitating chamber (the second chamber) R2 by a partition wall 29. Upward of the agitating chamber R2, a toner storage chamber R3 is formed with the partition wall 29 between, and inside the toner storage chamber R3 a replenishment toner (a non-magnetic toner) 28 is housed. The toner storage chamber R3 is installed with a replenishing port 26 and the amount of the replenishment toner 28 which corresponds to the toner consumed through the replenishing port 26 drops inside the agitating chamber R2 and replenished.

In contrast to this, inside the developing chamber R1 and the agitating chamber R2, the developer (the two component developer) 19 is housed. The developer 19 used in the present example is produced by a pulverizing method and is a two component developer, comprising: the non-magnetic toner (hereinafter referred to as “toner”) having a frictional electrification of about −2.0×10² C/kg and an average particle size of 8 μm; titanium oxide fine particles having an average particle size of 20 nm with 1% weight ratio externally added to the toner; and the magnetic carrier having a magnetization value of 2.7×10⁵ A/m in 0.1 tesla and an average particle size of 35 μm (a mixing ratio of the magnetic carrier is such that the non-magnetic toner has a weight ratio of about 7% for the whole developer).

In the portion adjacent to the photosensitive drum 3 of the developing container 27, an opening portion is installed and from this opening portion a developing sleeve (a non-magnetic cylinder) 21 is projected outside. The developing sleeve 21 is rotatably incorporated in the developing container 27 and, in the present example, the developing sleeve 21 comprises, for example, a non-magnetic material such as SUS305AC and, in its inside, a magnet 23 which is a magnetic a field generating means is fixed. Further, a developing sleeve having a diameter of 16 mm was used.

The magnet 23 comprises a developing magnetic pole N1, a developer layer thickness control pole S3 positioned in the developing magnetic pole N1 and in its downstream, magnetic poles N2 and S2 for conveying a developer 19 and a stripping off pole S1. The magnet 23 is arranged inside the developing sleeve 21 in such a manner that the developing magnetic pole N1 opposes to the photosensitive drum 3. The developing magnetic pole N1 forms a magnetic field in the vicinity of the developing portion between the developing sleeve 21 and the photosensitive drum 3 and a magnetic brush is formed by the magnetic field. In this position, the developer which has been conveyed in the arrow direction together with the developing sleeve 21 contacts the photosensitive drum 3 and the electrostatic latent image on the photosensitive drum 3 is developed.

On this occasion, in the vicinity position (the developing portion) between the developing sleeve 21 and the photosensitive drum 3, the developing sleeve 21 and the photosensitive drum 3 mutually moves in a reverse direction (a counter direction). The developer, which has completed the development at the N1 pole, is stripped off from the developing sleeve by the repulsive magnetic field formed by the S1 and the S3 poles and drops into the developing chamber R1.

The developing sleeve is applied with a vibration bias voltage with a direct current voltage superposed on an alternating current voltage by a power supply source 22. The dark portion potential (the nonexposure portion potential) and the light portion potential (the exposure portion potential) of the latent image is positioned between the maximum value and the minimum value of the above described vibration bias potential. In this way, in the developing portion, an alternating electric field in which the direction mutually changes is formed. In this alternating electric field, the toner and the carrier intensely vibrate and the toner amount corresponding to a latent image potential is adhered on the photosensitive drum 3 by shaking off an electrostatic restriction toward the developing sleeve 21 and the magnetic carrier. In the present example, the dark portion potential of the photosensitive drum 3 is taken as −550 V and the light portion potential as −100 V, and the developing sleeve 21 is applied with −300 V as a direct current bias and with Vpp2.0 kV, Frq. 6 kHz as an alternating current bias.

Downward of the developing sleeve 21, a blade 18 is arranged with the developing sleeve 21 at a predetermined interval. The interval between the developing sleeve 21 and the blade 18 is 400 μm. The blade 18 is fixed to the developing container 27. The blade 18 is composed of a magnetic material such as iron and magnetically controls a layer thickness of the developer 19 on the developing sleeve 21.

Inside the developing chamber R1, a conveyance screw (agitating conveyer means) 24 is housed. The conveyance screw 24 has a screw-shaped blade on an axis having a diameter of 6 mm, and the blade having a diameter of 14 mm and a pitch of 15 mm was used.

The conveyance screw 24 is rotated in a direction shown by the arrow in the drawing, and the developer 19 inside the developing chamber R1 is conveyed to the developing sleeve 21 at the whole area by a rotational drive of the conveyance screw 24 along a longitudinal direction of the developing sleeve 21. In the present example, the conveyance screw 24 is arranged downward in the gravitational direction to the developing sleeve 21. The reason will be described later, but it is because the topmost surface of the developer housed in the conveyance screw 24 is set between the developer layer thickness control pole and the stripping off pole.

Inside the agitating chamber R2, a conveyance screw 25 is housed. The conveyance screw 25 has the same shape as that of the conveyance screw 24 and has a screw-shaped blade on the axis of 6 mm, and a blade having a diameter of 14 mm and a pitch of 20 mm was used.

The conveyance screw 25 agitates and conveys the toner dropped from the replenishing port 26 at the whole area along the longitudinal direction of the developing sleeve 21, and delivers the sufficiently agitated developer to the developing chamber R1 side at its end.

Next, the positional relationship among the developer layer thickness control pole, the stripping off pole jointly forming a repulsive magnetic field and a screw in the vicinity of the developing sleeve including each operation thereof will be described in detail.

In the present example, among the S3 pole and the S1 pole which form the repulsive magnetic field, the S3 pole is used as the developer layer thickness control pole and the S1 pole as the developer stripping off pole. It is preferable that the peak value of the strength of the magnetic field in a vertical direction to the developing sleeve surface of the S3 pole be not less than 0.04 tesla and not more than 0.1 tesla, and the peak value of the strength of the magnetic field in a vertical direction to the sleeve surface of the S1 pole be not less than 0.04 tesla and not more than 0.08 tesla. Further, though the relationship of the strength of the magnetic field of the S3 pole and the S1 pole will be described later, the strength of the magnetic field of the S3 pole is made in the absolute value not less than 0 tesla and not more than 0.02 tesla larger than the strength of the magnetic field of the S1 pole. In the present example, the peak value of the strength of the magnetic field of the S3 pole was taken as 0.06 tesla and the peak value of the strength of the magnetic field of the S1 pole was taken as 0.05 tesla.

Further, on the developing sleeve, the positional relationship between the S3 pole and the S1 pole adopts such a constitution that the peak position of the strength of the magnetic field in the vertical direction to the developing sleeve surface of the stripping off pole S1 is positioned upward in the gravitational direction than the peak position of the strength of the magnetic field vertical to the developing sleeve surface of the developer layer thickness control magnetic pole S3.

If constituted in this way, the developer after development is easy to drop without requiring special stripping off means, and the developer can be easily conveyed to the developing portion by a magnetic suction by the developer layer thickness control pole. That is, regarding the stripping off of the developer from the developing sleeve and the supply of the developer to the developing sleeve, a simple constitution can be set up.

Further, the peak position of the strength of the magnetic field in the vertical direction to the developing sleeve surface of the S3 pole and the top end of the control blade (the developing sleeve side) are taken as making an angle of 5° (with the center position of the developing sleeve taken as a standard) in the present example.

Because a repulsive magnetic field is formed between the S3 pole and the S1 pole, the magnetic line of force of the S3 pole tends to emit vertically to the developing sleeve. As a result, a rate of change of the magnetic field (the density of the magnetic line of force) in the vertical direction to the developing sleeve becomes smaller. This is equivalent to the fact that the force attracting the developer to the developing sleeve becomes smaller. If such a constitution is adopted, the force by which the developer is compressed in the developer layer thickness control pole is weakened so that a deterioration of the developer such as a toner deterioration and occurrence of the spent carrier is controlled and the life of the developer can be extended.

However, in the case where one magnetic pole of the repulsive magnetic poles was used as the developer layer thickness control pole and the positional relationship on the developing sleeve between the developer layer thickness control pole S3 pole and the stripping off pole S1 pole was simply constituted in such a manner that the peak position of the strength of the magnetic field in the vertical direction to the developing sleeve surface of the stripping off pole S1 is positioned upward in the gravitational direction than the peak position of the strength of the magnetic field vertical to the developing sleeve surface of the developer layer thickness control magnetic pole S3, when the developer surface in the vicinity of the developing sleeve was relatively low, a screw pitch shaped density irregularity has occurred at the rear end of a solid black image.

This phenomenon occurs when, after the development is completed, the developer which has moved to the developer layer thickness control magnetic pole after having been stripped off by the repulsive magnetic field and the developer which has been agitated and conveyed by the screw and supplied to the developer layer thickness control pole are mixed and its mixing ratio changes in a longitudinal image area by a rotational cycle of the screw. Particularly when the toner density of the stripped off developer is low at the rear end of the image, it becomes a density irregularity and easily conspicuous.

As a result of the experimental study, it was found that, if the surface of the developer in the agitating screw in the vicinity of the developing sleeve is as follows, the screw pitch-shaped density irregularity is hard to occur. That is, it is enough to set up the developer surface between the peak position of the strength of the magnetic field vertical to the developing sleeve surface of the developer layer thickness control pole and the peak position of the strength of the magnetic field vertical to the developing sleeve surface of the stripping off pole. If the developer surface is set in this position, it is because the developer after having been stripped off is interrupted just by the fact that the developer exists there and is hard to spatially move to the developer layer thickness control pole and, further, it is because the mixing ratio of the developer supplied to the developer layer thickness control magnetic pole can be increased comparing with the amount of the developer having the image hysteresis after the stripping off.

Further, if the relationship of the strength of the magnetic field in the vertical direction to the developing sleeve surface of the two magnetic poles (in the present example, the S3 pole (the developer layer thickness control pole) and the S1 pole (the stripping off pole)) which form the repulsive magnetic field is as follows, the screw pitch-shaped density irregularity is hard to occur. This is a constitution where the absolute value of the strength of the magnetic field of the developer layer thickness control magnetic pole is 0.02 tesla not less than the absolute value of the strength of the magnetic field of the stripping off pole. If this relationship becomes larger than 0.02 tesla, it is because the developer, which has completed developing, is easy to move from the stripping off pole to the developer layer thickness control pole.

On this occasion, if the absolute value of the strength of the magnetic field of the developer layer thickness control magnetic pole is made the same or larger than the absolute value of the strength of the magnetic field of the stripping off pole, the circulation of the developer around the developing sleeve becomes smoother in the constitution such as that of the present example. When the strength of the developer layer thickness control pole is smaller than the strength of the magnetic field of the stripping off pole, the developer after development gathers too much in the stripping off pole and the developer reservoiring in the vicinity of the developer layer thickness control pole reversely becomes little so that the pressure to the developer in the developer layer thickness control portion becomes smaller and a coating irregularity of the developer on the developing sleeve is easy to occur. Further, in such a state, the developer surface becomes lower so that an irregularity of the supply amount on the developing sleeve by the rotation of the screw becomes the coating irregularity on the sleeve with a result that the screw pitch irregularity sometimes occurs.

Further, in the present example, as shown in FIG. 3, though the photosensitive drum 3 and the developing sleeve 21 are constituted in such a manner as to rotate in a counter direction in the developing portion, the present invention is not limited to this. However, as shown in FIG. 3, if the developer layer thickness is controlled downward in the gravitational direction of the developing device, it is easier to make a constitution such as that of the present constitution in which the condensation of the developer is small. The reason is because the developer which is not absorbed by the developing sleeve exists downward in the gravitational direction inside the container and, as its merits, it is cited that, in the case where the transfer portion is positioned downward of the photosensitive drum, if the developing sleeve and the photosensitive drum are constituted in such a manner as to rotate in a counter direction, the constitution of the developing device becomes simpler.

As described above, the full color printer using the two component developer is provided with the developer layer thickness control pole S3 and the stripping off pole S1 which comprises the same magnetic pole as the developer layer thickness control pole S3 and is arranged adjacent to the control pole at the upper side in the gravitational direction of control pole and forms the magnetic field for stripping off the two component developer supplied for development from the non-magnetic cylinder, wherein the peak value of the strength of the magnetic field of the developer layer thickness control pole S3 in the vertical direction to the outer periphery of the developing sleeve 21 is larger than the peak value of the strength of the magnetic field of the stripping off pole S1 in the vertical direction to the outer periphery by not less than 0 tesla and not more than 0.02 tesla in the absolute value and the conveyance screw 24 is arranged in such a manner that the topmost surface of the developer conveyed by the conveyance screw 24 is positioned between the peak position of the strength of the magnetic field of the developer layer thickness control pole S3 in the vertical direction to the outer periphery of the developing sleeve 21 and the peak position of the strength of the magnetic field of the stripping off pole S1 in the above described direction, so that further miniaturization of the apparatus and further longevity of the developer were attained and uniform solid black image without having any screw pitch-shaped density irregularity could be formed.

### EXAMPLE 2

In the present example, the magnetic carrier having a magnetization of 1.5×10⁵ A/m in the magnetic field of 0.1 tesla was used as the magnetic carrier in the two component developer. All the other conditions were taken as the same as those of Example 1.

Similar to Example 1, Example 2 is constituted in such a manner that one magnetic pole of the repulsive magnetic poles is taken as the developer layer thickness control magnetic pole and, further in the present example, by adopting the constitution where the strength of the magnetization of the carrier is made small, the compressive force of the developer in the developer layer thickness control pole is weakened, thereby the developer life is further extended.

However, in the case where the magnetization of the magnetic carrier is simply minimized, it is much harder than Example 1 to strip off the developer after development and the screw pitch-shaped density irregularity is easy to occur. This is because the carrier having a small magnetization becomes magnetically insensitive to the magnetic field and the developer after development is easy to move to the developer layer thickness control pole.

As a result of the experimental study, similar to the present example, the conveyance screw 24 is installed in such a manner that the topmost surface of the developer conveyed by the conveyance screw 24 is positioned between the peak position of the strength of the magnetic field of the developer layer thickness control pole S3 in the vertical direction to the outer periphery of the developing sleeve 21 and the peak position of the strength of the magnetic field of the stripping off pole S1 in the above described direction, so that further miniaturization of the apparatus and further longevity of the developer were attained and uniform solid black image without having any screw pitch-shaped density irregularity could be formed.

What is claimed is:

1. An image forming apparatus, comprising: a non-magnetic rotatable cylinder having a diameter of 10 mm to 25 mm; a plurality of magnetic field generating means which is inside the non-magnetic cylinder and fixed; a developing container which houses a two component developer containing a magnetic carrier and a non-magnetic toner and has said non-magnetic cylinder rotatably mounted at an opening portion thereof; agitating conveyer means which is inside the developing container and agitates the two component developer and conveys it to said non-magnetic cylinder; and an image bearing member arranged in opposition to the non-magnetic cylinder at intervals,
wherein said image forming apparatus is an image forming apparatus which conveys said two component developer by the rotation of the non-magnetic cylinder, and an electrostatic latent image on the image bearing member is magnetic-brush-developed,
said magnetic field generating means comprises: a developer layer thickness control pole for controlling a developer layer thickness on said non-magnetic cylinder of the developer supplied by the agitating conveyer means; and a stripping off pole comprising the same magnetic pole as the developer layer thickness control pole and arranged adjacent to the control pole in the upper side of the gravitational direction of the control pole and forming a magnetic field for stripping off the two component developer supplied for development from the non-magnetic cylinder,
the peak value of the strength of the magnetic field of said developer layer thickness control pole in the vertical direction to an outer peripheral surface of said non-magnetic cylinder is 0 tesla to 0.02 tesla in the absolute value not less than the peak value of the strength of the magnetic field of said stripping off pole in the vertical direction to the outer peripheral surface, and
said agitating conveyer means is installed in such a manner that the topmost surface of the developer conveyed by the agitating conveyer means is situated between the peak position of the strength of the magnetic field of said developer layer thickness control pole in the vertical direction to the outer peripheral surface of said non-magnetic cylinder and the peak position of the strength of the magnetic field of said stripping off pole in said direction.

2. The image forming apparatus according to claim 1, wherein said image bearing member and said non-magnetic cylinder mutually move in a reverse direction in a developing portion so that a development is performed.

3. The image forming apparatus according to claim 1, wherein the magnetic carrier in the two component developer has a magnetization of 3.0×10⁴ A/m to 2.0×10⁵ A/m in the magnetic field of 0.1 tesla.

4. The image forming apparatus according to claim 1, wherein the non-magnetic toner has a frictional electrification of −1×10⁻² to −4.5×10⁻² C/kg.

5. The image forming apparatus according to claim 1, wherein the non-magnetic toner has a volume average particle size of 4 μm to 15 μm.

6. The image forming apparatus according to claim 1, wherein the magnetic carrier has a weight average particle size of 20 μm to 100 μm.

7. The image forming apparatus according to claim 1, wherein the magnetic carrier has a weight average particle size of 20 μm to 70 μm.

8. The image forming apparatus according to claim 1, wherein the non-magnetic toner comprises the magnetic toner particle and an external additive, and
the external additive has a number average particle size not more than 1/10 of the numerical value of the weight average particle size of the magnetic toner particle.

9. The image forming apparatus according to claim 8, wherein the external additive is used in 0.01 part by weight to 10 parts by weight based on 100 parts by weight of the non-magnetic toner particle.

10. The image forming apparatus according to claim 8, wherein the external additive is used in 0.05 part by weight to 5 parts by weight based on 100 parts by weight of the non-magnetic toner particle.

11. The image forming apparatus according to claim 1, wherein the magnetic carrier in the two component developer has a magnetization of 3.0×10⁴ A/m to 2.0×10⁵ A/m in the magnetic field of 0.1 tesla,
the non-magnetic toner has a frictional electrification of −1×10⁻² C/kg to −4.5×10⁻² C/kg,
the non-magnetic toner has a volume average particle size of 4 μm to 15 μm,
the magnetic carrier has a weight average particle size of 20 μm to 70 μm,
the non-magnetic toner comprises the magnetic toner particle and the external additive,
the external additive has a number average particle size of the numerical value of not more than 1/10 of the numerical value of the weight average particle size of the magnetic toner particle, and
the external additive is used in 0.05 part by weight to 5 parts by weight based on 100 parts by weight of the non-magnetic toner particle.

12. The image forming apparatus according to claim 2, wherein the magnetic carrier in the two component developer has a magnetization of 3.0×10⁴ A/m to 2.0×10⁵ A/m in the magnetic field of 0.1 tesla,
the non-magnetic toner has a frictional electrification of −1×10⁻² C/kg to −4.5×10⁻² C/kg,
the non-magnetic toner has a volume average particle size of 4 μm to 15 μm,
the magnetic carrier has a weight average particle size of 20 μm to 70 μm,
the non-magnetic toner comprises the magnetic toner particle and the external additive,
the external additive has a number average particle size of the numerical value of not more than 1/10 of the numerical value of the weight average particle size of the magnetic toner particle, and
the external additive is used in 0.05 part by weight to 5 parts by weight based on 100 parts by weight of the non-magnetic toner particle.

13. An image forming method, comprising: a non-magnetic rotatable cylinder having a diameter of 10 mm to 25 mm; a plurality of magnetic field generating means which is inside the non-magnetic cylinder and fixed; a developing container which houses a two component developer containing a magnetic carrier and a non-magnetic toner and has said non-magnetic cylinder rotatably mounted at an opening portion thereof; agitating conveyer means which is inside the developing container and agitates the two component developer and conveys it to said non-magnetic cylinder; and an image bearing member arranged in opposition to the non-magnetic cylinder at intervals,
wherein said image forming apparatus is an image forming apparatus which conveys said two component developer by the rotation of the non-magnetic cylinder and an electrostatic latent image on the image bearing member is magnetic-brush-developed,
said magnetic field generating means comprises: a developer layer thickness control pole for controlling a developer layer thickness on said non-magnetic cylinder of the developer supplied by the agitating conveyer means; and a stripping off pole comprising the same magnetic pole as the developer layer thickness control pole and arranged adjacent to the control pole in the upper side of the gravitational direction of the control pole and forming the magnetic field for stripping off the two component developer supplied for development from the non-magnetic cylinder,
the peak value of the strength of the magnetic field of said developer layer thickness control pole in the vertical direction to an outer peripheral surface of said non-magnetic cylinder is 0 tesla to 0.02 tesla in the absolute value not less than the peak value of the strength of the magnetic field of said stripping off pole in the vertical direction to the outer peripheral surface, and
said agitating conveyer means is installed in such a manner that the top most surface of the developer conveyed by the agitating conveyer means is situated between the peak position of the strength of the magnetic field of said developer layer thickness control pole in the vertical direction to the outer peripheral surface of said non-magnetic cylinder and the peak position of the strength of the magnetic field of said stripping off pole in said direction.

14. The image forming method according to claim 13, wherein the non-magnetic cylinder is, at a development time, applied with a vibration bias.

15. The image forming method according to claim 13, wherein said image bearing member and said non-magnetic cylinder mutually move in a reverse direction in a developing portion so that a development is performed.

16. The image forming method according to claim 13, wherein the magnetic carrier in the two component developer has a magnetization of 3.0×10⁴ A/m to 2.0×10⁵ A/m in the magnetic field of 0.1 tesla.

17. The image forming method according to claim 13, wherein the non-magnetic toner has a frictional electrification of −1×10⁻² C/kg to −4.5×10⁻² C/kg.

18. The image forming method according to claim 13, wherein the non-magnetic toner has a volume average particle size of 4 μm to 15 μm.

19. The image forming method according to claim 13, wherein the magnetic carrier has a weight average particle size of 20 μm to 100 μm.

20. The image forming method according to claim 13, wherein the magnetic carrier has a weight average particle size of 20 μm to 70 μm.

21. The image forming method according to claim 13, wherein the non-magnetic toner comprises the magnetic toner particle and an external additive, and
the external additive has a number average particle size not more than 1/10 of the numerical value of the weight average particle size of the magnetic toner particle.

22. The image forming method according to claim 21, wherein the external additive is used in 0.01 part by weight to 10 parts by weight based on 100 parts by weight of the non-magnetic toner particle.

23. The image forming method according to claim 21, wherein the external additive is used in 0.05 part by weight to 5 parts by weight based on 100 parts by weight of the non-magnetic toner particle.

24. The image forming method according to claim 13, wherein the magnetic carrier in the two component developer has a magnetization of 3.0×10⁴ A/m to 2.0×10⁵ A/m in the magnetic field of 0.1 tesla,
the non-magnetic toner has a frictional electrification of −1×10⁻² C/kg to −4.5×10² C/kg,
the non-magnetic toner has a volume average particle size of 4 μm to 15 μm,
the magnetic carrier has a weight average particle size of 20 μm to 70 μm,
the non-magnetic toner comprises the magnetic toner particle and the external additive,
the external additive has a number average particle size of the numerical value of not more than 1/10 of the numerical value of the weight average particle size of the magnetic toner particle, and
the external additive is used in 0.05 part by weight to 5 parts by weight based on 100 parts by weight of the non-magnetic toner particle.

25. The image forming method according to claim 15, wherein the magnetic carrier in the two component developer has a magnetization of 3.0×10⁴ A/m to 2.0×10⁵ A/m in the magnetic field of 0.1 tesla,
the non-magnetic toner has a frictional electrification of −1×10⁻² C/kg to −4.5×10⁻² C/kg,
the non-magnetic toner has a volume average particle size of 4 μm to 15 μm,
the magnetic carrier has a weight average particle size of 20 μm to 70 μm,
the non-magnetic toner comprises the magnetic toner particle and the external additive,
the external additive has a number average particle size of the numerical value of not more than 1/10 of the numerical value of the weight average particle size of the magnetic toner particle, and
the external additive is used in 0.05 part by weight to 5 parts by weight based on 100 parts by weight of the non-magnetic toner particle.

26. A developing apparatus, comprising: a non-magnetic rotatable cylinder having a diameter of 10 mm to 25 mm; a plurality of magnetic field generating means which is inside the non-magnetic cylinder and fixed; a developing container which houses a two component developer containing a magnetic carrier and a non-magnetic toner and has said non-magnetic cylinder rotatably mounted at an opening portion thereof; agitating conveyer means which is inside the developing container and agitates the two component developer and conveys it to said non-magnetic cylinder,
wherein said developing apparatus is a developing apparatus which conveys said two component developer by the rotation of the non-magnetic cylinder and an electrostatic latent image on an image bearing member of an image forming apparatus is magnetic-brush-developed the image bearing member being arranged in opposition to the non-magnetic cylinder at intervals,
said magnetic field generating means comprises: a developer layer thickness control pole for controlling a developer layer thickness on said non-magnetic cylinder of the developer supplied by the agitating conveyer means; and a stripping off pole comprising the same magnetic pole as the developer layer thickness control pole and arranged adjacent to the control pole in the upper side of the gravitational direction of the control pole and forming the magnetic field for stripping off the two component developer supplied for development from the non-magnetic cylinder,
the peak value of the strength of the magnetic field of said developer layer thickness control pole in the vertical direction to an outer peripheral surface of said non-magnetic cylinder is 0 tesla to 0.02 tesla in the absolute value not less than the peak value of the strength of the magnetic field of said stripping off pole in the vertical direction to the outer peripheral surface, and
said agitating conveyer means is installed in such a manner that the topmost surface of the developer conveyed by the agitating conveyer means is situated between the peak position of the strength of the magnetic field of said developer layer thickness control pole in the vertical direction to the outer peripheral surface of said non-magnetic cylinder and the peak position of the strength of the magnetic field of said stripping off pole in said direction.

27. The developing apparatus according to claim 26, wherein said image bearing member and said non-magnetic cylinder mutually move in a reverse direction in a developing portion so that a development is performed.

28. The developing apparatus according to claim 26, wherein the magnetic carrier in the two component developer has a magnetization of 3.0×10⁴ A/m to 2.0×10⁵ A/m in the magnetic field of 0.1 tesla.

29. The developing apparatus according to claim 26, wherein the non-magnetic toner has a frictional electrification of −1×10⁻² C/kg to −4.5×10⁻² C/kg.

30. The developing apparatus according to claim 26, wherein the non-magnetic toner has a volume average particle size of 4 μm to 15 μm.

31. The developing apparatus according to claim 26, wherein the magnetic carrier has a weight average particle size of 20 μm to 100 μm.

32. The developing apparatus according to claim 26, wherein the magnetic carrier has a weight average particle size of 20 μm to 70 μm.

33. The developing apparatus according to claim 26, wherein the non-magnetic toner comprises the magnetic toner particle and an external additive, and
the external additive has a number average particle size not more than 1/10 of the numerical value of the weight average particle size of the magnetic toner particle.

34. The developing apparatus according to claim 33, wherein the external additive is used in 0.01 part by weight to 10 parts by weight based on 100 parts by weight of the non-magnetic toner particle.

35. The developing apparatus according to claim 33, wherein the external additive is used in 0.05 part by weight to 5 parts by weight based on 100 parts by weight of the non-magnetic toner particle.

36. The developing apparatus according to claim 26, wherein the magnetic carrier in the two component developer has a magnetization of 3.0×10⁴ A/m to 2.0×10⁵ A/m in the magnetic field of 0.1 tesla,
the non-magnetic toner has a frictional electrification of −1×10⁻² C/kg to −4.5×10⁻² C/kg,
the non-magnetic toner has a volume average particle size of 4 μm to 15 μm,
the magnetic carrier has a weight average particle size of 20 μm to 70 μm,
the non-magnetic toner comprises the magnetic toner particle and the external additive,
the external additive has a number average particle size of the numerical value of not more than 1/10 of the numerical value of the weight average particle size of the magnetic toner particle, and
the external additive is used in 0.05 part by weight to 5 parts by weight based on 100 parts by weight of the non-magnetic toner particle.

37. The developing apparatus according to claim 27, wherein the magnetic carrier in the two component developer has a magnetization of 3.0×10⁴ A/m to 2.0×10⁵ A/m in the magnetic field of 0.1 tesla,
the non-magnetic toner has a frictional electrification of −1×10⁻² C/kg to −4.5×10⁻² C/kg,
the non-magnetic toner has a volume average particle size of 4 μm to 15 μm,
the magnetic carrier has a weight average particle size of 20 μm to 70 μm,
the non-magnetic toner comprises the magnetic toner particle and the external additive,
the external additive has a number average particle size of the numerical value of not more than 1/10 of the numerical value of the weight average particle size of the magnetic toner particle, and
the external additive is used in 0.05 part by weight to 5 parts by weight based on 100 parts by weight of the non-magnetic toner particle.
